(19) United States
(12) Patent Application Publication
(10) Pub. No.: US 2019/0244210 A1
(43) Pub. Date: Aug. 8, 2019

(54) TRANSACTION CARD WITH FINGERPRINT IDENTIFICATION FUNCTION

(71) Applicant: BEAUTIFUL CARD CORPORATION, TAOYUAN CITY (TW)

(72) Inventor: MENG-JEN CHENG, TAOYUAN CITY (TW)

(21) Appl. No.: 15/997,777

(22) Filed: Jun. 5, 2018

(30) Foreign Application Priority Data
Feb. 6, 2018 (TW) 107104149

(51) Int. Cl. G06Q 20/40; G06K 19/07; G06Q 20/34; H01Q 1/22

(52) U.S. Cl. CPC G06Q 20/40145; H01Q 1/22; G06Q 20/34; G06K 19/0723

(57) ABSTRACT

A transaction card with fingerprint identification function includes a card body, on which a fingerprint identification and transaction processor, an energy-storage capacitor, a fingerprint sensing receiver, a control switch, a display unit, a contactless RF antenna and a contact communication unit are arranged. In use, the contactless RF antenna or the contact communication unit can obtain external electricity needed by the transaction card to work, while the energy-storage capacitor is charged at the same time to store backup electricity. After the needed external electricity is obtained, the control switch enables the fingerprint sensing receiver and the fingerprint identification and transaction processor to receive and identify a card user's fingerprint. The transaction is performed only when the received fingerprint is identified to be the cardholder's fingerprint, and the display unit will display fingerprint identification message and transaction message. Therefore, it is able to ensure enhanced safety of transaction.

### CROSS-REFERENCE TO RELATED APPLICATION

This non-provisional application claims priority under 35 U.S.C. § 119(a) on Patent Application No(s). 107104149 filed in Taiwan, R.O.C. on Feb. 6, 2018, the entire contents of which are hereby incorporated by reference.

### FIELD OF THE INVENTION

The present invention relates to a transaction card, and more particularly, to a transaction card with fingerprint identification function.

### BACKGROUND OF THE INVENTION

The commonly used electronic transaction cards, such as financial cards, credit cards, stored-value cards, easy cards and the like, can be divided into contact transaction cards and contactless transaction cards according to the manner in which the cards are used. A contact transaction card has a security chip exposed from the card surface for electrical contacting with an external card reader, so that the card reader can read required data from the security chip to perform a transaction with the transaction card. On the other hand, a contactless transaction card has an induction coil and a unique radio-frequency (RF) tag embedded therein. When a user approaches the contactless transaction card to a read module, an electromagnetic induction occurs between an antenna of the read module and the induction coil in the transaction card to produce induced electric current, allowing the read module to read data of the RF tag for performing a required transaction.

However, the conventional electronic transaction cards do not provide any function of identifying a cardholder or a consumer, and are frequently subjected to the problems of identify theft, no matter the transaction card is stolen or not. And, when making a transaction with the card, the consumer can usually be informed by the store whether the transaction has been completed, and no transaction state will be displayed on the card. Therefore, the cardholder is subjected to the risk of personal and transaction data leakage during or after the transaction, and the safety of using the conventional electronic transaction cards just could not be ensured.

It is therefore tried by the inventor to develop a transaction card with fingerprint identification function, which is able to receive and identify a cardholder's fingerprint, such that a transaction via the transaction card of the present invention will be performed only when the received fingerprint is identified to be the cardholder's fingerprint. With the transaction card of the present invention, the safety of transaction using an electronic transaction card can be largely upgraded to effectively overcome the problems of the conventional electronic transaction cards.

### SUMMARY OF THE INVENTION

In view of the disadvantages of the prior art transaction cards, a primary object of the present invention is to provide a transaction card with fingerprint identification function, which can receive and identify a card user's fingerprint, so that a transaction via the transaction card will be performed only when the received fingerprint has been identified to be the cardholder's fingerprint. Therefore, it is able to ensure enhanced safety of transaction.

To achieve the above and other objects, the transaction card with fingerprint identification function according to a preferred embodiment of the present invention includes a card body; a fingerprint identification and transaction processor arranged on the card body; an energy-storage capacitor arranged on the card body and electrically connected to the fingerprint identification and transaction processor; a fingerprint sensing receiver arranged on the card body and electrically connected to the fingerprint identification and transaction processor; a control switch arranged on the card body and electrically connected to the fingerprint identification and transaction processor; a display unit arranged on the card body and electrically connected to the fingerprint identification and transaction processor; a contactless RF antenna arranged on the card body and electrically connected to the fingerprint identification and transaction processor; and a contact communication unit arranged on the card body and electrically connected to the fingerprint identification and transaction processor.

In the transaction card with fingerprint identification function according to the present invention, the card body includes a carrier, a front printed layer, a front transparent protective layer, a back printed layer, and a back transparent protective layer. The fingerprint identification and transaction processor, the energy-storage capacitor, the fingerprint sensing receiver, the control switch, the display unit, the contactless RF antenna and the contact communication unit all are arranged on the carrier. The front printed layer is disposed on a front side of the carrier, the front transparent protective layer is disposed on a top side of the front printed layer, the back printed layer is disposed on a back side of the carrier, and the back transparent protective layer is disposed on a top side of the back printed layer. The front printed layer and the front transparent protective layer are simultaneously provided with a window, which are located corresponding to the contact communication unit. The front printed layer is provided with a switch pattern, which is located corresponding to the control switch; or, the front printed layer and the front transparent protective layer can be simultaneously provided with a switch pattern, which are located corresponding to the control switch. And, the front printed layer is also provided with another window, which is located corresponding to the display unit. Or, the front printed layer and the front transparent protective layer can be simultaneously provided with another window, which are located corresponding to the display unit.

In the transaction card with fingerprint identification function according to the present invention, the carrier is provided with a recessed section, in which the fingerprint sensing receiver is disposed to thereby has a top surface located lower than a top surface of the carrier; and the front printed layer and the front transparent protective layer are simultaneously provided with a further window, which are located corresponding to the fingerprint sensing receiver.

In the transaction card with fingerprint identification function according to the present invention, the fingerprint sensing receiver can be otherwise arranged on the carrier to be flush with the top surface of the carrier.

In the transaction card with fingerprint identification function according to the present invention, the fingerprint identification and transaction processor includes a storage unit and a security module.

In the transaction card with fingerprint identification function according to the present invention, the energy-storage capacitor can be a rigid supercapacitor or a flexible supercapacitor.

In the transaction card with fingerprint identification function according to the present invention, the fingerprint sensing receiver can be a rigid fingerprint sensing receiver or a flexible fingerprint sensing receiver.

The transaction card with fingerprint identification function according to the present invention can further include a rectifier and stabilizer unit arranged on the card body and electrically connected to between the fingerprint identification and transaction processor, the energy-storage capacitor, the contactless RF antenna and the contact communication unit.

In the transaction card with fingerprint identification function according to the present invention, the control switch can be any one of a leaf-spring switch, a resistance touch switch, a capacitance switch and a fingerprint switch.

In the transaction card with fingerprint identification function according to the present invention, the display unit can include a flexible display, at least one light-emitting element, or a combination thereof.

With the above arrangements, when the transaction card with fingerprint identification function according to the present invention is in use, the contactless RF antenna or the contact communication unit can obtain external electricity needed by the transaction card to work, while the energy-storage capacitor is charged at the same time to store backup energy. After the needed external electricity is obtained, the control switch enables the fingerprint sensing receiver and the fingerprint identification and transaction processor to receive and identify a card user's fingerprint. The transaction is performed only when the received fingerprint is identified to be the cardholder's fingerprint, and the display unit will display fingerprint identification message and transaction message. Therefore, it is able to ensure enhanced safety of transaction via the transaction card.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a transaction card with fingerprint identification function according to a preferred embodiment of the present invention;

FIG. 2 is an exploded view of FIG. 1;

FIG. 3 is an assembled sectional view of FIG. 1; and

FIG. 4 is a block diagram of the transaction card with fingerprint identification function according to the preferred embodiment of the present invention.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

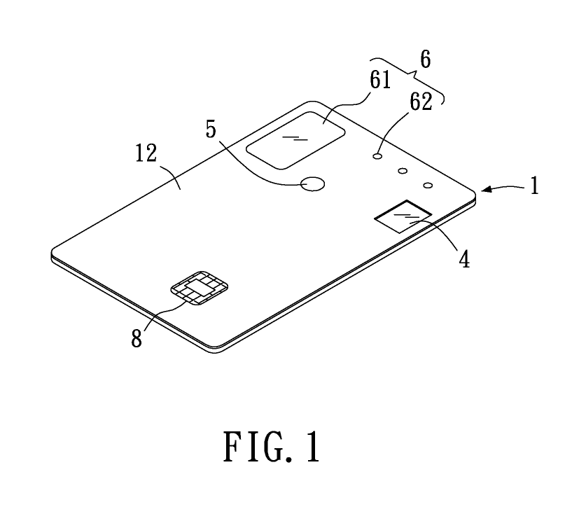

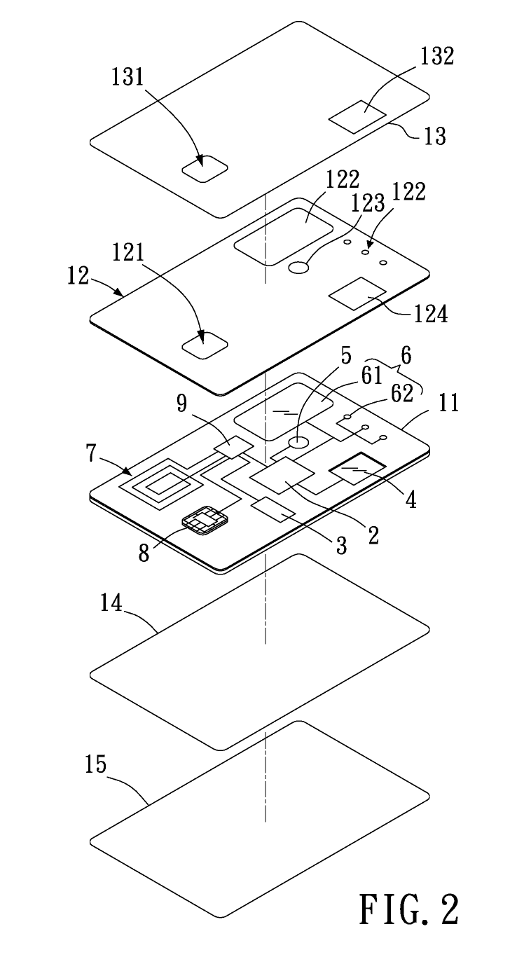

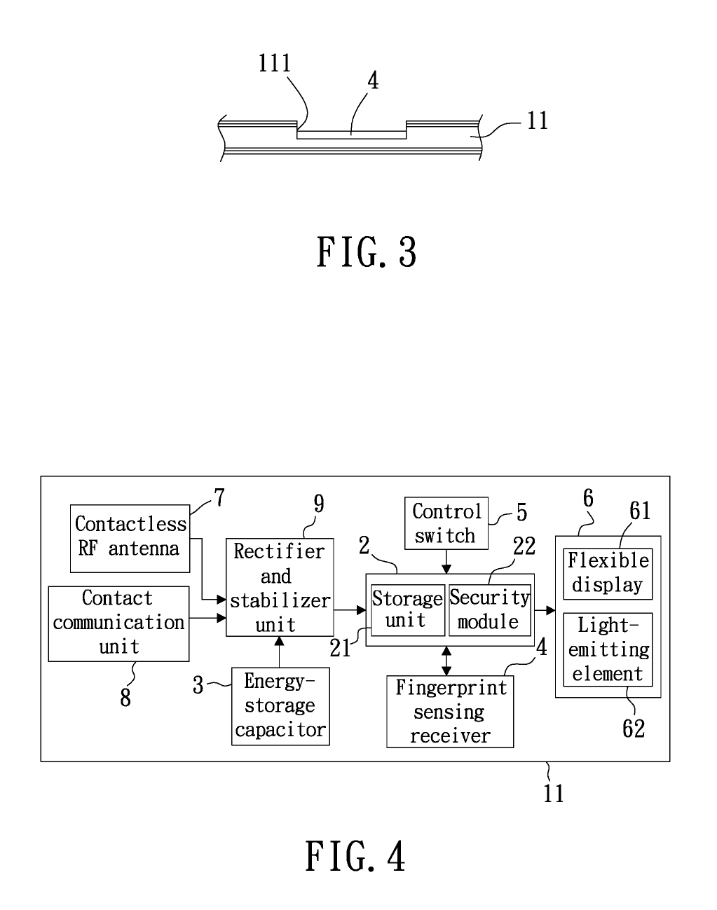

Please refer to FIGS. 1 to 4. A transaction card with fingerprint identification function according to a preferred embodiment of the present invention includes at least a card body 1, a fingerprint identification and transaction processor 2, an energy-storage capacitor 3, a fingerprint sensing receiver 4, a control switch 5, a display unit 6, a contactless radio-frequency (RF) antenna 7, and a contact communication unit 8. For the purpose of conciseness, the present invention is also briefly referred to as the transaction card herein.

The fingerprint identification and transaction processor 2 is arranged on the card body 1 for storing a user's fingerprint data, personal data and transaction data, and performing required computation process during fingerprint identification and transaction.

The energy-storage capacitor 3 is arranged on the card body 1 and electrically connected to the fingerprint identification and transaction processor 2. The energy-storage capacitor 3 can be a supercapacitor for storing electrical energy, which is to be used as backup electrical energy.

The fingerprint sensing receiver 4 is arranged on the card body 1 and electrically connected to the fingerprint identification and transaction processor 2 for receiving a user's fingerprint data.

The control switch 5 is arranged on the card body 1 and electrically connected to the fingerprint identification and transaction processor 2. When the transaction card gets required electricity, the control switch 5 enables the fingerprint identification and transaction processor 2 as well as the fingerprint sensing receiver 4 and controls the process of fingerprint identification.

The display unit 6 is arranged on the card body 1 and electrically connected to the fingerprint identification and transaction processor 2 for showing necessary reminders to the user in different modes during the fingerprint identification and the transaction.

The contactless RF antenna 7 is arranged on the card body 1 and electrically connected to the fingerprint identification and transaction processor 2, and can be an induction coil for obtaining an external power supply, so that the transaction card can be used to perform a contactless transaction.

The contact communication unit 8 is arranged on the card body 1 and electrically connected to the fingerprint identification and transaction processor 2, and can be an integrated circuit (IC) chip to function in a contact transaction.

When using the transaction card of the present invention to perform a contactless transaction, the user first approaches the card body 1 to a read module (not shown), allowing the contactless RF antenna 7 to read the electromagnetic wave from the read module, so that induced electric current is produced for the transaction card to operate. When the transaction card obtains the required external electricity, the control switch 5 enables the fingerprint sensing receiver 4 as well as the fingerprint identification and transaction processor 2, and the user touches the fingerprint sensing receiver 4 with his/her one finger that has the default fingerprint. At this point, the fingerprint sensing receiver 4 receives the user's fingerprint and the fingerprint identification and transaction processor 2 starts receiving and identifying the fingerprint. When it is confirmed the received fingerprint is the cardholder's fingerprint, the display unit 6 automatically outputs a confirmation message, which can be any type of a light or a text message, and the fingerprint identification and transaction processor 2 starts exchanging the user's personal data and transaction data with the read module. Then, the display unit 6 automatically outputs a transaction message, which can be any type of a light or a text message, informing the user/consumer the transaction is under processing or the transaction has been processed. When the transaction is completed and the card body 1 is removed from the read module, the contactless RF antenna 7 can no longer read any electromagnetic wave from the read module, and the card body 1 goes into an electrical disconnected state, which in turn brings the fingerprint identification and transaction processor 2 as well as the fingerprint sensing receiver 4 to an inactive state, and the display unit 6 no longer outputs any transaction message, so as to remind the user/consumer the current transaction has ended and the transaction card is now in a non-use state. On the other hand, in the event it is found the received fingerprint is not the cardholder's fingerprint, the display unit 6 will automatically output an error message, which can be any type of a light or a text message, and the fingerprint identification and transaction processor 2 is disabled. Therefore, the transaction card with fingerprint identification function according to the present invention can ensure upgraded safety of contactless transaction.

When using the transaction card of the present invention to perform a contact transaction, the user first insert the card body 1 into a card reader (not shown), allowing the contact communication unit 8 to electrically contact with the card reader, so that electric current needed for the transaction card to operate is supplied from the card reader to the card body 1 via the contact communication unit 8. When the transaction card obtains the required external electricity, the control switch 5 enables the fingerprint sensing receiver 4 as well as the fingerprint identification and transaction processor 2, and the user touches the fingerprint sensing receiver 4 with his/her one finger that has the default fingerprint. At this point, the fingerprint sensing receiver 4 receives the user's fingerprint and the fingerprint identification and transaction processor 2 starts receiving and identifying the fingerprint. When it is confirmed the received fingerprint is the cardholder's fingerprint, the display unit 6 automatically outputs a confirmation message, which can be any type of a light or a text message, and the fingerprint identification and transaction processor 2 starts exchanging the user's personal data and transaction data with the card reader. Then, the display unit 6 automatically outputs a transaction message, which can be any type of a light or a text message, informing the user/consumer the transaction is under processing or the transaction has been processed. When the transaction is completed and the card body 1 is removed from the card reader, the card body 1 can no longer receive any electricity from the card reader via the contact communication unit 8 and goes into an electrical disconnected state, which in turn brings the fingerprint identification and transaction processor 2 as well as the fingerprint sensing receiver 4 to an inactive state, and the display unit 6 no longer outputs any transaction message, so as to remind the user/consumer the current transaction has ended and the transaction card is now in a non-use state. On the other hand, in the event it is found the received fingerprint is not the cardholder's fingerprint, the display unit 6 will automatically output an error message, which can be any type of a light or a text message, and the fingerprint identification and transaction processor 2 is disabled. Therefore, the transaction card with fingerprint identification function according to the present invention can ensure upgraded safety of contact transaction.

Further, when the contactless RF antenna 7 or the contact communication unit 8 obtains external electricity from the read module or the card reader, respectively, the energy-storage capacitor 3 is simultaneously charged for storing backup electricity, which can be supplied to the card body 1 when the contactless RF antenna 7 or the contact communication unit 8 fails to obtain external electricity.

According to an operable embodiment of the present invention, the card body 1 includes a carrier 11, a front printed layer 12, a front transparent protective layer 13, a back printed layer 14, and a back transparent protective layer 15. The fingerprint identification and transaction processor 2, the energy-storage capacitor 3, the fingerprint sensing receiver 4, the control switch 5, the display unit 6, the contactless radio-frequency (RF) antenna 7 and the contact communication unit 8 all are arranged on the carrier 11. The front printed layer 12 is disposed on a front side of the carrier 11 to cover the fingerprint identification and transaction processor 2, the energy-storage capacitor 3, the fingerprint sensing receiver 4 and the contactless RF antenna 7. The front transparent protective layer 13 is disposed on a top side of the front printed layer 12. The back printed layer 14 is disposed on a back side of the carrier 11, and the back transparent protective layer 15 is disposed on a top side of the back printed layer 14. The front printed layer 12 and the front transparent protective layer 13 are simultaneously provided with a window 121, 131, respectively, which are located corresponding to the contact communication unit 8. The front printed layer 12 is also provided with at least another window 122, which is located corresponding to the display unit 6. In an operable embodiment, the front transparent protective layer 13 can also be provided with at least one another window (not shown), which is located corresponding to the display unit 6. In the illustrated preferred embodiment, only the front printed layer 12 is provided with another window 122. Further, the front printed layer 12 can also be provided with a switch pattern 123, which is located corresponding to the control switch 5. In an operable embodiment, the front transparent protective layer 13 can also be provided with a switch pattern (not shown), which is located corresponding to the control switch 5. The carrier 11 can be a flexible printed circuit (FPC), a printed circuit board (PCB) or an FR-4 (flame retardant grade 4) PCB. The front printed layer 12, the front transparent protective layer 13, the back printed layer 14 and the back transparent protective layer 15 can be made of an ABS (acrylonitrile butadiene styrene), a PETG (polyethylene terephthalate glycol-modified), a PVC (polyvinyl chloride) or a PET (polyethylene terephthalate) material.

According to an operable embodiment of the present invention, the carrier 11 is provided with a recessed section 111, in which the fingerprint sensing receiver 4 is disposed. The front printed layer 12 and the front transparent protective layer 13 are simultaneously provided with a further window 124, 132, respectively, which are located corresponding to the fingerprint sensing receiver 4. In this way, the fingerprint sensing receiver 4 has a top surface located lower than a top surface of the carrier 11 and is therefore effectively protected from being scratched during storage or usage. Alternatively, according to actual need in use, the fingerprint sensing receiver 4 can be otherwise arranged on the carrier 11 to be flush with the top surface of the carrier 11 (not shown). And, the fingerprint sensing receiver 4 can be a rigid or a flexible member. With these arrangements, the transaction card of the present invention is more practical for use.

According to an operable embodiment of the present invention, the fingerprint identification and transaction processor 2 includes a storage unit 21 and a security module 22. The storage unit 21 has user's fingerprint data, personal data and transaction data stored thereon; and the security module 22 can perform computation process during fingerprint identification and transaction.

According to an operable embodiment of the present invention, the transaction card further includes a rectifier and stabilizer unit 9, which is arranged on the carrier 11 of the card body 1 and electrically connected to between the fingerprint identification and transaction processor 2, the energy storage capacitor 3, the contactless RF antenna 7 and the contact communication unit 8. The rectifier and stabilizer unit 9 serves to stabilize voltage when the transaction card is in use, lest the fingerprint identification and transaction processor 2 should be damaged due to instable working voltage. The rectifier and stabilizer unit 9 can be covered by the front printed layer 12.

According to an operable embodiment of the present invention, the control switch 5 can be any one of a leaf-spring switch, a resistance touch switch, a capacitance switch and a fingerprint switch to meet different applications and manufacturing requirements.

According to an operable embodiment of the present invention, the display unit 6 includes a flexible display 61, at least one light-emitting element 62, or a combination thereof. A display mode for the flexible display 61 can preset in the fingerprint identification and transaction processor 2, so as to use the flexible display 61 to output relevant text messages. The light-emitting element 62 can be a light-emitting diode. When producing the transaction card, a display mode for the light-emitting element 62, such as to emit light steadily, to emit blinking light, to emit light in cycles, or to change light colors, can be preset in the fingerprint identification and transaction processor 2, so as to use the light-emitting element 62 to output related messages. With these arrangements, the display unit 6 can meet different displaying requirements.

The present invention has been described with some preferred embodiments thereof and it is understood that the preferred embodiments are only illustrative and not intended to limit the present invention in any way and many changes and modifications in the described embodiments can be carried out without departing from the scope and the spirit of the invention that is intended to be limited only by the appended claims.

The claims are as follows:

1. A transaction card with fingerprint identification function, comprising:
a card body;
a fingerprint identification and transaction processor arranged on the card body;
an energy-storage capacitor arranged on the card body and electrically connected to the fingerprint identification and transaction processor;
a fingerprint sensing receiver arranged on the card body and electrically connected to the fingerprint identification and transaction processor;
a control switch arranged on the card body and electrically connected to the fingerprint identification and transaction processor;
a display unit arranged on the card body and electrically connected to the fingerprint identification and transaction processor;
a contactless RF antenna arranged on the card body and electrically connected to the fingerprint identification and transaction processor; and
a contact communication unit arranged on the card body and electrically connected to the fingerprint identification and transaction processor;
wherein the transaction card obtains an external electricity via the contactless RF antenna or the contact communication unit, the control switch enables the fingerprint identification and transaction processor and the fingerprint sensing receiver, the fingerprint sensing receiver receives a fingerprint and the fingerprint identification and transaction processor receives and identifies the fingerprint.

2. The transaction card with fingerprint identification function as claimed in claim 1, wherein the card body includes a carrier, a front printed layer, a front transparent protective layer, a back printed layer, and a back transparent protective layer; the fingerprint identification and transaction processor, the energy-storage capacitor, the fingerprint sensing receiver, the control switch, the display unit, the contactless RF antenna and the contact communication unit all being arranged on the carrier; the front printed layer being disposed on a front side of the carrier, the front transparent protective layer being disposed on a top side of the front printed layer, the back printed layer being disposed on a back side of the carrier, and the back transparent protective layer being disposed on a top side of the back printed layer; the front printed layer and the front transparent protective layer being simultaneously provided with a window, which are located corresponding to the contact communication unit; the front printed layer being provided with a switch pattern, which is located corresponding to the control switch; or, the front printed layer and the front transparent protective layer being simultaneously provided with a switch pattern, which are located corresponding to the control switch; and the front printed layer also being provided with another window, which is located corresponding to the display unit; or, the front printed layer and the front transparent protective layer being simultaneously provided with another window, which are located corresponding to the display unit.

3. The transaction card with fingerprint identification function as claimed in claim 2, wherein the carrier is provided with a recessed section, in which the fingerprint sensing receiver is disposed to thereby has a top surface located lower than a top surface of the carrier; and the front printed layer and the front transparent protective layer being simultaneously provided with a further window, which are located corresponding to the fingerprint sensing receiver.

4. The transaction card with fingerprint identification function as claimed in claim 2, wherein the fingerprint sensing receiver is arranged on the carrier to be flush with a top surface of the carrier.

5. The transaction card with fingerprint identification function as claimed in claim 1, wherein the fingerprint identification and transaction processor includes a storage unit and a security module.

6. The transaction card with fingerprint identification function as claimed in claim 1, wherein the energy-storage capacitor is selected from the group consisting of a rigid supercapacitor and a flexible supercapacitor.

7. The transaction card with fingerprint identification function as claimed in claim 1, wherein the fingerprint sensing receiver is selected from the group consisting of a rigid fingerprint sensing receiver and a flexible fingerprint sensing receiver.

8. The transaction card with fingerprint identification function as claimed in claim 1, further comprising a rectifier and stabilizer unit arranged on the card body and electrically connected to between the fingerprint identification and transaction processor, the energy-storage capacitor, the contactless RF antenna and the contact communication unit.

9. The transaction card with fingerprint identification function as claimed in claim 1, wherein the control switch is selected from the group consisting of a leaf-spring switch, a resistance touch switch, a capacitance switch and a fingerprint switch.

10. The transaction card with fingerprint identification function as claimed in claim 1, wherein the display unit includes a flexible display, at least one light-emitting element, or a combination thereof.
